(19) United States
(12) Patent Application Publication
(10) Pub. No.: US 2011/0173176 A1
(43) Pub. Date: Jul. 14, 2011

(54) Automatic Generation of an Interest Network and Tag Filter

(75) Inventors: James E. Christensen, Cortlandt Manor, NY (US); Stephen E. Levy, Honolulu, HI (US); Daniel M. Gruen, Newton, MA (US); Susanne C. Hupfer, Lexington, MA (US); Jamie C. Rasmussen, Somerville, MA (US); Steven I. Ross, South Hamilton, MA (US)

(73) Assignee: INTERNATIONAL BUSINESS MACHINES CORPORATION, Armonk, NY (US)

(21) Appl. No.: 12/639,784

(22) Filed: Dec. 16, 2009

(51) Int. Cl. G06F 17/30

(52) U.S. Cl. 707/709; 707/E17.108

(57) ABSTRACT

Computer system and method automatically generate a social interest network. The social interest network indicates or represents (1) respective relevance between system users and taggers, and (2) respective affinity between users and taggers. A tag-based search engine searches and retrieves tagged contents. The search engine also retrieves semantic information associated with the tagged contents and tagger. Semantic information about the searcher-user is compared to the search retrieved semantic information. A comparator determines respective relevance of taggers to the searcher-user and respective affinity of the searcher-user to the taggers. The social interest network results and enables collaboration between users/taggers and filtering of various search results.

### GOVERNMENT SUPPORT

This invention was made with Government support under Distillery Phase IV-H98230-07-C-0383 awarded by a United States of America Intelligence Agency. The Government has certain rights to this invention.

### BACKGROUND

Blogs, Bookmarking systems, and wikis allow the tagging of entries for later search and identification. This tagging function has been further extended by associating the person that generated the tag with that tag allowing a searcher to find a person who appears to be interested in the same content. Through the use of Lightweight Directory Access Protocol (LDAP) systems, individuals identified can be further discriminated based on corporate affiliations, societies, etc. This requires the searcher to both 1) know what organizations, areas of research, and/or publications are relevant to the search domain and 2) perform this repetitive and tedious search.

Users conduct these searches to find other individuals working in their area for potential collaboration and in the corporate world, to prevent duplication of effort.

### BRIEF SUMMARY

Systems such as Twine identify concepts and entities found in searches, but do not utilize them to generate a social interest network or help shape the presentation of search results other than by filtering the search results. Others have stated the importance of storing social network metadata with semantic data about a topic, but do not allow other resources to be utilized for generating an interest network.

Further, others proposed finding people of interest by mining all their content within an organization and finding shared topics of interest based on word frequency. Such an approach does not utilize semantic information about the document, tags, or contributors.

The present invention addresses the shortcomings and disadvantages of the prior art. In particular, the present invention addresses the problem of taggers tagging content with the same word for different purposes. Thus the present invention provides a way to disambiguate which tags “sense” of the tag is meant by the tagger and by the searcher. Embodiments of the invention try to find taggers whose interests and expertise overlap those of the searcher in an attempt to use this to disambiguate the tag-sense, and provide the searcher with results tagged by people who probably meant the same thing (definition, use) by the tag as the searcher did.

In the course of maintaining the information about who is interested in what tags and what information, a social interest network is produced, but for the purposes of tagging and searching. This aspect of the invention helps the system produce good search results. A secondary benefit is achieved by exposing the information in the social interest network more directly so that users can discover others with similar interests, etc.

Embodiments of the present invention include:

1. A method to utilize semantic information associated with individuals tagging content to automatically generate an interest network for collaboration, and

2. A method to utilize the associated interest network to help filter the results of a tag search to favor those tags that are probably more relevant based on the presumed affinity the searcher has to the other taggers.

3. A computer system comprising:
a tag-based search engine responsive to a searcher-user, the tag-based search engine searching contents in a global and/or local computer network including tagged contents, and retrieving tags matching searcher-user defined criteria,
for each matching tag, the tag-based search engine retrieving:
semantic information stored in the matching tag and corresponding content of the matching tag, and
semantic information of a person who generated the matching tag, resulting in search retrieved semantic information;
a comparator responsive to and comparing the search retrieved semantic information to semantic information of the searcher-user, the comparator determining (i) respective relevance of each person who generated one of the matching tags to the searcher-user and/or (ii) searcher-user respective affinity to each person who generated one of the matching tags; and
a data store holding indications of the search retrieved semantic information, the determined respective relevance and/or searcher-user respective affinity and semantic information of the searcher-user in a manner forming a social interest network. The social interest network is automatically generated by the comparator and search engine operations over various searches. The social interest network enables collaboration among system users (and taggers).

The present invention proposes using the semantic information known about an individual who has generated a tag, and any semantic metadata associated with the content posting to determine if that individual is relevant and working in the same area as the person performing the original search (the searcher-user). The resulting determined relevant individuals are then indicated in or otherwise used to form a social interest network (database).

The invention system using the known semantic information of the searcher, compares that to the individuals identified by the tags. The proposed social interest network could then be ranked based on the relevance of the selected individuals to the searcher-user.

In addition, subsequent searches are improved by filtering the results based on the social interest network created.

In some embodiments, a display member displays indications of:

respective relevance of each or some of those who generated one of the matching tags with respect to the searcher-user, and

the searcher-user respective affinity to each or some of those who generated one of the matching tags.

In embodiments, a filter is coupled to receive determinations made by the comparator and responsively filters the matching tags and corresponding content. A display member then displays indications of the filtered matching tags and corresponding content.

In some embodiments, the semantic information of the searcher-user held in the data store includes indications of any one or more of tags, taggers, entities, work areas and concepts identified as important in prior searches.

Further, the retrieved semantic information of people who generated the matching tags may be drawn from data resources having machine readable semantic information about people.

### BRIEF DESCRIPTION OF THE SEVERAL VIEWS OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic view of a computer network in which embodiments of the present invention operate.

FIG. 2 is a block diagram of computer nodes in the network of FIG. 1.

FIG. 3 is a schematic view of one embodiment of the present invention.

FIG. 4 is a flow diagram of one embodiment of the present invention.

### DETAILED DESCRIPTION

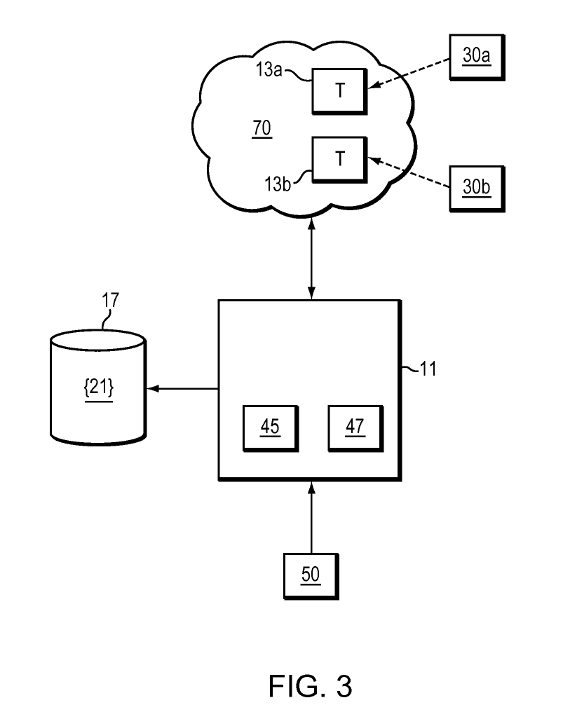

With reference now to FIG. 3, a tag-based search system 11 of the present invention is illustrated. Various users (at client's 30a,b . . . ) of a computer network 70 (i.e., a global network such as the Internet, or a local database network), tag respective content including web pages, blogs, wikis, etc. as illustrated by tags 13a,b . . . (referenced 13 generally). Each tag 13 includes an indication of the respective user 30 (generally) who generated the tag. Such user 30 may be referred to as the “tagger” or tag generator with respect to the tag 13.

Tag-based search system 11 is responsive to tag requests/query commands of client 50 users. In this sense, client user 50 is referred to as the searcher-user. Tag-based search system 11 in response retrieves from the computer network 70 tags 13 (and corresponding contents) matching the searcher-user 50 query. Common query matching techniques are used. In addition, for each matching tag 13, the tag-based search system 11 retrieves semantic information stored with the tag 13 and semantic information about the respective tagger 30.

Tagger 30 semantic information may be drawn from various resources including DBpedia, LDAP, patent and other publication databases, and the like. Essentially, any data resource that has machine readable semantic information about people may be utilized by tag-based search system 11. See for example Stephen Downes at www.downes.ca/cgi-bin/page.cgi?post=31624.

Next, the tag-based search system 11 (comparator 45 thereof) compares the retrieved semantic information (both that stored with tags 13 and that about respective taggers 30) to semantic data (and other machine readable data) on the searcher-user 50. The semantic data on the searcher-user 50 includes: entities (tags 13, taggers 30), work areas/concepts (or subjects) identified as important in prior search results. Known comparison algorithms and techniques are employed. This comparison, by comparator 45 for example, determines (1) respective affinity of searcher-user 50 to taggers 30 of matched/retrieved tags 13, and (2) respective relevance of each such tagger 30 to the searcher-user 50. The determination is based on same topic area, work area, etc. found in the semantic information of taggers 30 as exist in the semantic information of searcher-user 50.

The tag-based search system 11 stores in semantic database 17 the semantic information of retrieved tags 13, respective taggers 30 and of searcher-user 50. The tag-based search system 11 also stores in semantic database 17 indications of determined relevance/affinity between searcher-user 50 and taggers 30 as determined by the above comparison. In this way, database 17 supports or represents an automatically generated social interest network 21 of the present invention. The tag-based search system 11 maintains semantic database 17 (and effectively social interest network 21) as a collection of information. This collection of information then helps to filter 47 new searches (subsequent tag searches) for relevance based on the entities (searcher-users 50, tags 13, taggers 30) and concepts identified as important from the previous searches. Various data store configurations and techniques for database 17 are suitable.

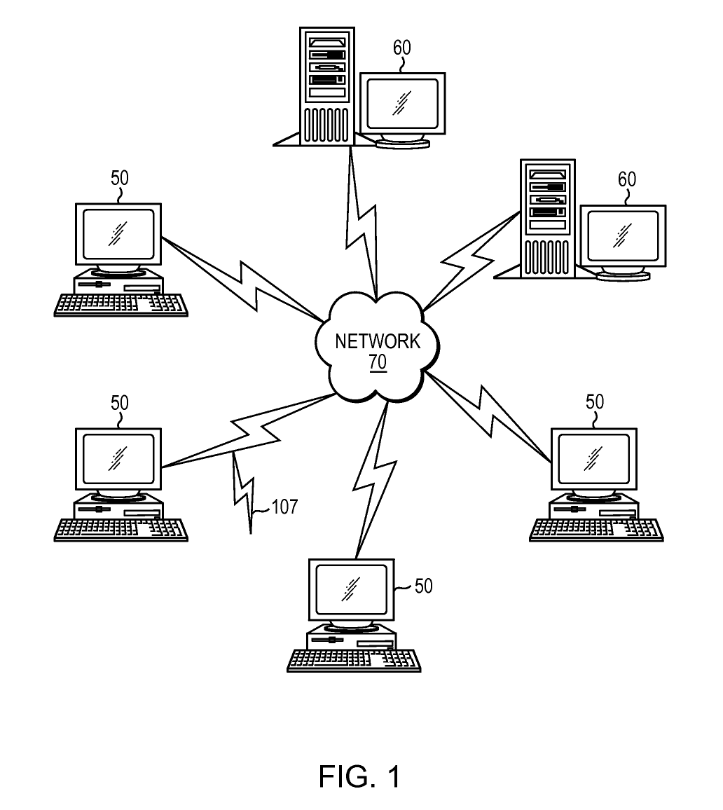

FIG. 1 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. Client computers 50 include tagger clients 30. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

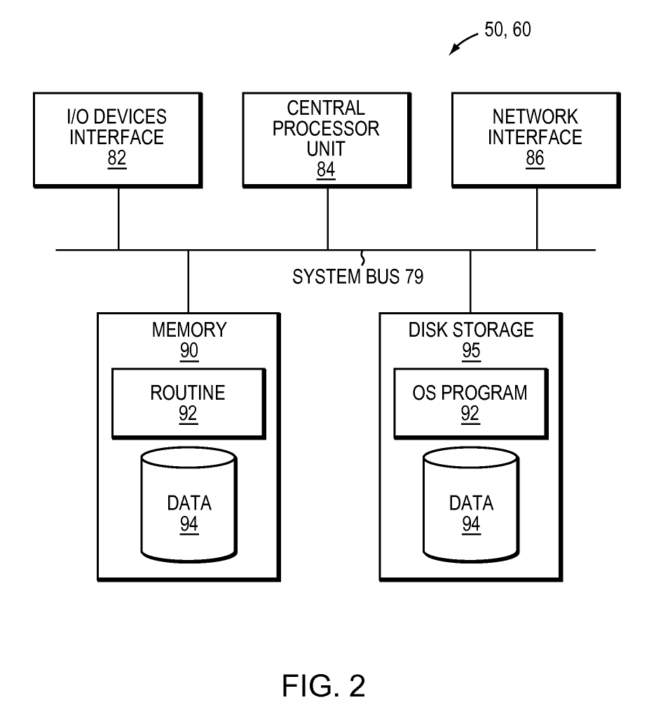

FIG. 2 is a diagram of the internal structure of a computer (e.g., client processor/device 50 or server computers 60) in the computer system of FIG. 1. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 1). Memory 90 provides volatile storage for computer software instructions 92 and data 94 used to implement an embodiment of the present invention (e.g., tag-based search system/engine 11, comparator 45, tag search results filter 47 and supporting code detailed above and below). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

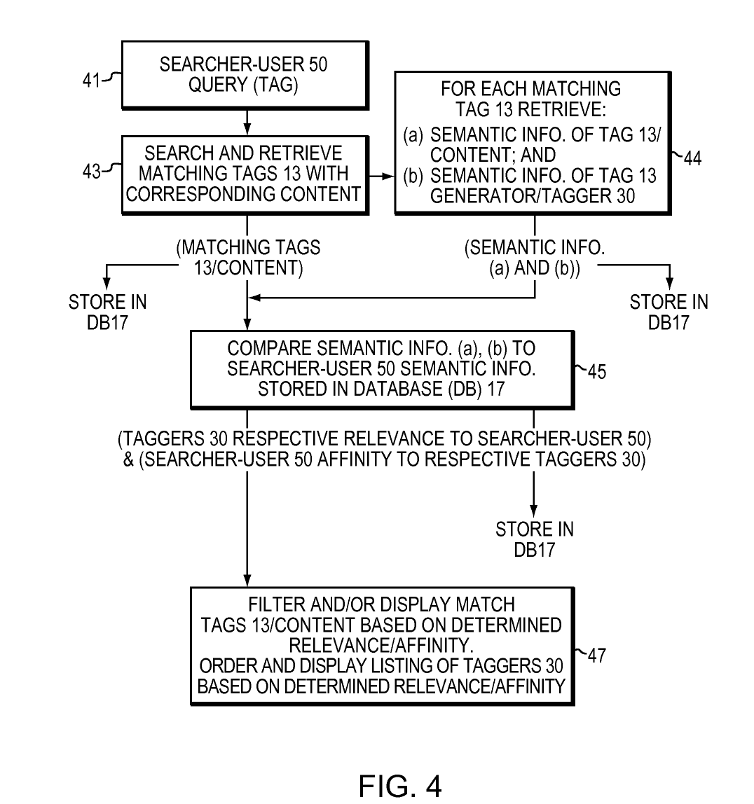

Referring now to FIG. 4, is a flow diagram of one embodiment of tag-based search system and engine 11. Search system/engine 11 receives as input a search query or request 41 from a searcher-user 50. The search query 41 preferably specifies tags that the searcher-user 50 is looking for (generally searcher-user defined criteria). Search engine 11 responds by searching 43 the computer network 70 (e.g., the Internet) and retrieving tags 13 matching the query 41. Along with the matching tags 13, step 43 retrieves corresponding contents of those tags. Known techniques for step 43 searching and retrieving are employed.

Next, for each matching tag 13 retrieved, step 44 retrieves (a) semantic information stored with the tag 13 and the corresponding content, and (b) semantic information about the tagger 30 (i.e., the person who generated that tag). Step 44 employs known data extraction techniques.

The results of steps 43 and 44 are stored to semantic database 17. That is, system 11 stores a copy or indication of the matching tags 13 and contents in database 17 and stores the retrieved semantic information of matching tags 13/content and respective taggers 30 in database 17. System 11 stores this information in database 17 for use in comparator 45 in this search 41 and subsequent ones.

Step 45 compares (i) the retrieved semantic information (of matching tags 13/content and respective taggers 30) to (ii) semantic information of the searcher-user 50 stored in database 17. The searcher-user 50 semantic data includes tags 13, taggers 30, other entities, work areas, concepts and so on identified as important in prior search results. Comparator 45 may use various scoring and other known mechanisms of comparison. With results of the comparison, step 45 determines (i) taggers 30 respective relevance to searcher-user 50 and (ii) searcher-user 50 affinity to respective taggers 30.

Step 45 outputs indications of these two determinations. System 11 stores the indications in semantic database 17 to update and maintain social interest network 21. Meanwhile, step 47 uses these determinations to filter and display the search results (matching tags 13 and corresponding content). Common techniques for filtering are employed.

Comparator 45/system 11 may generate other output based on the two determinations made by step 45. In one embodiment, system 11 (by filter 47) outputs and displays an ordered listing of taggers' 30 names based on the determined relevance to and affinity of the current searcher-user 50. Other indicators of the automatically generated social interest network 21 and other output are suitable. In this way, social interest network 21 enables collaboration among system users (including taggers).

Accordingly, the present invention addresses the problem of taggers tagging content with the same word for different purposes. Thus the present invention provides a way to disambiguate which tags “sense” of the tag is meant by the tagger and by the searcher. Embodiments of the invention try to find taggers whose interests and expertise overlap those of the searcher in an attempt to use this to disambiguate the tag-sense, and provide the searcher with results tagged by people who probably meant the same thing (definition, use) by the tag as the searcher did.

In the course of maintaining the information about who is interested in what tags and what information, a social interest network is produced, but for the purposes of tagging and searching. This aspect of the invention helps the system produce good search results. A secondary benefit is achieved by exposing the information in the social interest network more directly so that users can discover others with similar interests, etc.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While this invention has been particularly shown and described with references to example embodiments thereof, it will be understood by those skilled in the art that various changes in form and details may be made therein without departing from the scope of the invention encompassed by the appended claims.

What is claimed is:

1. A computer system comprising:
a tag-based search engine responsive to a searcher-user, the tag-based search engine searching contents in a computer network including tagged contents, and retrieving tags matching searcher-user defined criteria,
for each matching tag, the tag-based search engine retrieving:
semantic information stored in the matching tag and corresponding content of the matching tag, and
semantic information of a person who generated the matching tag, resulting in search retrieved semantic information;
a comparator responsive to and comparing the search retrieved semantic information to semantic information of the searcher-user, the comparator determining respective relevance of each person who generated one of the matching tags to the searcher-user; and
a data store holding indications of the search retrieved semantic information, the determined respective relevance and semantic information of the searcher-user in a manner forming a social interest network.

2. A computer system as claimed in claim 1 wherein the comparator further determines searcher-user respective affinity to each person who generated one of the matching tags; and
the data store further holds indications of determined searcher-user respective affinity.

3. A computer system as claimed in claim 2 further comprising a display member displaying indications of:
respective relevance of each or some of those who generated one of the matching tags with respect to the searcher-user, and
the searcher-user respective affinity to each or some of those who generated one of the matching tags.

4. A computer system as claimed in claim 1 further comprising:
a filter coupled to receive determinations made by the comparator and responsively filtering the matching tags and corresponding content; and
a display member displaying indications of the filtered matching tags and corresponding content.

5. A computer system as claimed in claim 1 wherein the semantic information of the searcher-user held in the data store includes indications of any one or more of tags, taggers, entities, work areas and concepts identified as important in prior searches.

6. A computer system as claimed in claim 1 wherein the retrieved semantic information of people who generated the matching tags is drawn from data resources having machine readable semantic information about people.

7. A computer system as claimed in claim 1 wherein the social interest network is automatically generated through the tag based search engine and comparator operating on various searches.

8. A computer system as claimed in claim 1 wherein the formed social interest network enables collaboration among system users.

9. A computer system as claimed in claim 1 wherein the formed social interest network enables filtering of results of tag-based searches by a user to favor portions of the results that are more relevant based on affinity of the user to other taggers according to the formed social interest network.

10. A computer implemented method, comprising:
(a) conducting a tag-based search responsive to a searcher-user by searching tagged contents in a computer network, and retrieving tags matching searcher-user defined criteria,
(b) for each matching tag, retrieving:
semantic information stored in the matching tag and corresponding content of the matching tag, and
semantic information of a person who generated the matching tag, resulting in search retrieved semantic information;
(c) comparing the search retrieved semantic information to semantic information of the searcher-user, the comparing determining respective relevance of each person who generated one of the matching tags to the searcher-user; and
(d) holding in a data store indications of the search retrieved semantic information, the determined respective relevance and semantic information of the searcher-user in a manner forming a social interest network.

11. A computer implemented method as claimed in claim 10 further comprising:
determining searcher-user respective affinity to each person who generated one of the matching tags; and
further holding in the data store indications of determined searcher-user respective affinity.

12. A computer implemented method as claimed in claim 11 further comprising:
displaying as output indications of:
respective relevance of each or some of those who generated one of the matching tags with respect to the searcher-user, and
the searcher-user respective affinity to each or some of those who generated one of the matching tags.

13. A computer implemented method as claimed in claim 10 further comprising:
based on determinations made by the comparing, filtering the matching tags and corresponding content; and
displaying on output indications of the filtered matching tags and corresponding content.

14. A computer implemented method as claimed in claim 10 wherein the semantic information of the searcher-user held in the data store includes indications of any one or more of tags, taggers, entities, work areas and concepts identified as important in prior searches.

15. A computer implemented method as claimed in claim 10 wherein the retrieved semantic information of people who generated the matching tags is drawn from data resources having machine readable semantic information about people.

16. A computer implemented method as claimed in claim 10 wherein the social interest network is automatically generated through the steps of conducting a tag based search, retrieving semantic information and comparing operating on various searches.

17. A computer implemented method as claimed in claim 10 wherein the formed social interest network enables collaboration among system users.

18. A computer implemented method as claimed in claim 10 wherein the formed social interest network enables filtering of results of tag-based searches by a user.

19. A computer implemented method as claimed in claim 18 wherein filtering by the social interest network favors portions of the results that are likely more relevant based on affinity of the user to other taggers according to the social interest network.

20. A computer program product for automatically generating a social interest network, the computer program product comprising:
a computer readable storage medium having computer readable program code embodied therewith, the computer readable program code comprising computer readable program code configured to:
search tagged contents and retrieve tags matching searcher-user defined criteria;
for each matching tag, retrieve (i) semantic information stored in the matching tag and corresponding tag content, and (ii) semantic information of a tagger of the matching tag, resulting in search retrieved semantic information;
determine respective relevance of taggers to the searcher user and/or respective searcher-user affinity to different taggers, by comparing the search retrieved semantic information to semantic information of the searcher-user; and
automatically generate a social interest network from the determinations.
